(19) United States
(12) Patent Application Publication
(10) Pub. No.: US 2017/0170912 A1
(43) Pub. Date: Jun. 15, 2017

(54) MULTIMEDIA SHARING METHOD AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yin LI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,050

(22) Filed: Aug. 22, 2016

Related U.S. Application Data
(63) Continuation of application No. PCT/CN2016/089523, filed on Jul. 10, 2016.

(30) Foreign Application Priority Data
Dec. 10, 2015 (CN) 2015109088277

(51) Int. Cl. H04B 11/00

(52) U.S. Cl. CPC H04B 11/00; H04L 5/0055

(57) ABSTRACT

Embodiments of the present disclosure relate to the field of communications technologies, and disclose a multimedia-sharing method and user's equipment. The method includes: collecting to-be-shared video information selected by a user; generating an acoustic wave signal corresponding to the video information; and sending the acoustic wave signal.

### CROSS-REFERENCE TO RELATED APPLICATIONS

This application is a continuation of International Application No. PCT/CN2016/089523, with an international filing date of Jul. 10, 2016, which is based upon and claims priority to Chinese Patent Application No. 201510908827.7, filed on Dec. 10, 2015, the entire contents of all of which are incorporated herein by reference.

### TECHNICAL FIELD

Embodiments of the present disclosure relate to the field of communications technologies, and more particularly, to a multimedia sharing method and an electronic device.

### BACKGROUND

Multimedia sharing refers to that a user shares a video he or she likes to another user, so as to promote interpersonal communication and increase the number of views of the video, such that more users may watch the video. In conventional methods, a user generally shares a video to another user via a mobile phone number registered by the user, or an account registered, such as a WeChat account, a Microblog account, QQ account or the like.

However, by using these conventional methods, a user may not share a video to another user who does not have such accounts. For example, if another user who a user just knows is not a friend in these accounts, it may be difficult for the user to share a video with the another user.

### SUMMARY

To resolve a technical problem that a method for sharing a video rapidly and conveniently that does not require user accounts is not provided in the prior art, an embodiment of the present disclosure provides a multimedia sharing method, the method includes: collecting to-be-shared video information selected by a user; generating an acoustic wave signal corresponding to the video information; and sending the acoustic wave signal.

According to an embodiment of the present disclosure, there is provided with an electronic device. The electronic device includes: at least one processor; and a memory communicably connected with the at least one processor to perform any of above disclosed methods.

According to an embodiment of the present disclosure, there is provided with another electronic device. The another electronic device includes: at least one processor; and a memory communicably connected with the at least one processor to parse a received acoustic wave signal to obtain the corresponding video information, wherein the received acoustic wave signal corresponds to to-be-shared video information selected by a user.

### BRIEF DESCRIPTION OF THE DRAWINGS

The accompanying drawings are used to provide a further understanding of embodiments of the present disclosure, and constitute a part of the specification, which are used to explain the present disclosure in combination with the detailed embodiments wherein after, and do not constitute a limitation to the present disclosure. In the accompanying drawings:

FIG. 1 is a schematic diagram of an interaction process illustrating multimedia sharing between two user equipments according to an embodiment of the present disclosure;

FIG. 2 is a schematic structural diagram illustrating a user equipment at a sending end according to an embodiment of the present disclosure;

FIG. 3 is a schematic structural diagram illustrating a user equipment at a receiving end according to an embodiment of the present disclosure;

FIG. 4 is an exemplary flowchart illustrating a multimedia sharing method at a sending end according to an embodiment of the present disclosure;

FIG. 5 is an exemplary flowchart illustrating a multimedia sharing method at a receiving end according to an embodiment of the present disclosure; and

FIG. 6 is a schematic hardware diagram of an electronic device for performing a multimedia sharing method according to an embodiment of the present disclosure.

### DETAILED DESCRIPTION

Specific implementation manners of the embodiments of the present disclosure are described in detail below with reference to the accompanying drawings. It should be understood that the specific implementation manners described herein are merely for the purpose of illustrating and explaining the present disclosure, but are not intended to limit the present disclosure.

Concepts of the present invention are illustrated with examples below, but it should be understood that these examples are non-limitative examples, and the protection scope of the present disclosure is not limited to these example.

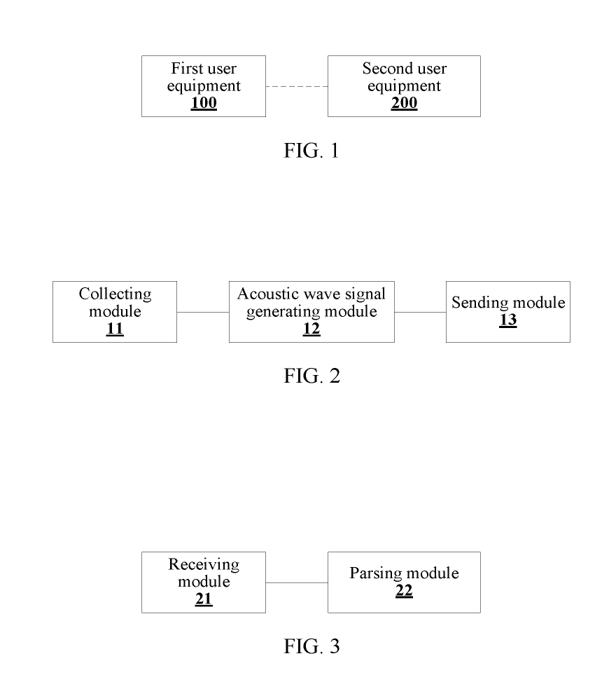

To illustrate ideas of the present disclosure more clearly, details are described by using a first user equipment 100 as an example of a sending end, using a second user equipment 200 as an example of a sending end, and using an interaction process between the first user equipment 100 and the second user equipment 200 as an example. FIG. 1 is a schematic diagram illustrating an interaction process of multimedia sharing between two user equipments according to an embodiment of the present disclosure. The dashed line represents a video sharing stream between the two user equipments, and the first user equipment 100 and the second user equipment 200 may be respectively configured as a user equipment at a sending end and a user equipment at a receiving end that are provided by the present invention. It should be understood that the first user equipment 100 and the second user equipment 200 may be devices such as mobile phones, computers, and tablet computers.

FIG. 2 is a schematic structural diagram illustrating a user equipment at a sending end according to an embodiment of the present disclosure. As illustrated in FIG. 2, a user equipment (for example, the first user equipment 100) may include: a collecting module 11, configured to collect to-be-shared video information selected by a user; an acoustic wave signal generating module 12, configured to generate an acoustic wave signal corresponding to the video information; and a sending module 13, configured to send the acoustic wave signal. By means of such configurations, the to-be-shared video information may be sent out. The video information includes a video address. For example, the sending module may further send a request for transmitting the acoustic wave signal, and send the acoustic wave signal in response to a positive acknowledgement for the request. The sending module is a loudspeaker.

Correspondingly, FIG. 3 is a schematic structural diagram illustrating a user equipment at a receiving end according to an embodiment of the present disclosure. As illustrated in FIG. 3, a user equipment (for example, the second user equipment 200) may include: a receiving module 21, configured to receive an acoustic wave signal corresponding to to-be-shared video information selected by a user; and a parsing module 22, configured to parse the received acoustic wave signal to obtain the corresponding video information. For example, the receiving module may be a microphone. With such configuration, video information shared by other people except a user himself or herself may be received and the video may be watched.

For example, at the sending end, when the first user equipment 100 desires to share a video with other people (for example, with the second user equipment 200), the collecting module 11 of the first user equipment 100 may collect to-be-shared video information selected by a user of the first user equipment 100. For example, the video information is a video address of the video A, and the process of collecting the video address is similar to the prior art (that is, extracting an IP address of the video A). To make the protection scope of the present invention clear, details are not described herein. Later, the acoustic wave signal generating module 12 of the first user equipment 100 may generate an acoustic wave signal corresponding to the video information (for example, converting a digital signal of the video address to an analog signal). Then, the acoustic wave signal is sent to the second user equipment 200 through the sending module 13. For example, the acoustic wave signal is sent to the second user equipment 200 through a loudspeaker of the first user equipment 100.

At the receiving end, the receiving module 21 of the second user equipment 200 may (for example, within a particular range) receive an acoustic wave signal sent by the first user equipment 100, for example, receive the acoustic wave signal through a microphone of the second user equipment 200. Later, the parsing module 22 of the second user equipment 200 may parse the received acoustic wave signal to obtain the corresponding video information, for example, to obtain the video address of the video A. For example, the video address is displayed on a display screen of the second user equipment 200, and the video may be played by clicking the video address. By means of such an implementation manner, a user may share a video with another user nearby rapidly and conveniently by using acoustic waves instead of third-party accounts (for example, registered mobile phone numbers, WeChat, Microblog, QQ or the like).

To be more user-friendly, considering that the second user equipment 200 may not want to receive a shared video, or it is not convenient for the second user equipment 200 to receive the shared video currently (for example, the user equipment needs to be charged or is in a call), a sending module of a user equipment (for example, the sending module 13 of the first user equipment 100) provided by the present invention may further be configured to first send the second user equipment 200 a request for transmitting the acoustic wave signal (for example, “** device sends video sharing to you, receive or not?”). If the second user equipment 200 desires to receive, it will respond to the request (for example, a positive acknowledgement “yes”). In this case, upon receiving the positive acknowledgement of the second user equipment 200 for the request, the sending module 13 of the first user equipment 100 sends the acoustic wave signal to the second user equipment 200.

Actually, the first user equipment 100 and the second user equipment 200 are not limited to the above implementation manner, and may have functions of a sending end and a receiving end at the same time. For example, in addition to being configured with a receiving module and a parsing module of a receiving end, the second user equipment may also be configured with a collecting module, an acoustic wave signal generating module, and a sending module of a sending end. Similarly, in addition to being configured with a collecting module, an acoustic wave signal generating module, and a sending module of a sending end, a first user equipment may also be configured with a receiving module and a parsing module of a receiving end. In this way, bidirectional video sharing between two user equipment is achieved.

For example, the second user equipment 200 may also realize sharing of a to-be-shared video by means of an interaction process that is reverse to the above interaction process. For example, when the second user equipment 200 desires to share a video B with other people (for example, with the first user equipment 100), the collecting module of the second user equipment 200 may collect to-be-shared video information selected by a user of the second user equipment 200, for example, the video information is a video address of the video B. Later, the acoustic wave signal generating module of the second user equipment 200 may generate an acoustic wave signal corresponding to the video information (for example, converting a digital signal of the video address to an analog signal). Then, the acoustic wave signal is sent to the first user equipment 100 through the sending module. For example, the acoustic wave signal is sent to the first user equipment 100 through a loudspeaker of the second user equipment 200.

At the receiving end, the receiving module of the first user equipment 100 may (for example, within a particular range) receive an acoustic wave signal sent by the second user equipment 200, for example, receive the acoustic wave signal through a microphone of the first user equipment 100. Later, the parsing module of the first user equipment 100 may parse the received acoustic wave signal to obtain the corresponding video information, for example, to obtain the video address of the video B. For example, the video address is displayed on a display screen of the first user equipment 100, and the video may be played by clicking the video address. By means of such an implementation manner, a user may share a video with another user nearby rapidly and conveniently by using acoustic waves instead of third-party accounts (for example, registered mobile phone numbers, WeChat, Microblog, QQ or the like).

To be more user-friendly, a sending module of the second user equipment 200 (for example, the sending module of the second user equipment 200) may further be configured to first send the first user equipment 100 a request for transmitting the acoustic wave signal (for example, “** device sends a video sharing request to you, receive or not?”). If the first user equipment 100 desires to receive, it will respond to the request (for example, a positive acknowledgement “yes”). In this case, upon receiving the positive acknowledgement of the first user equipment 100 for the request, the sending module of the second user equipment 200 sends the acoustic wave signal to the first user equipment 100.

It should be understood that the first user equipment and the second user equipment in this application are merely exemplary and non-limitative examples. The first user equipment shown as a sending end may also send an acoustic wave signal to multiple user equipments besides the second user equipment, and the second user equipment shown as a receiving end may also receive acoustic wave signals from multiple user equipments besides the first user equipment. In addition, as mentioned above, the sending end and the receiving end of the first user equipment and the second user equipment may be exchanged, which is not limited in the embodiments of the present disclosure.

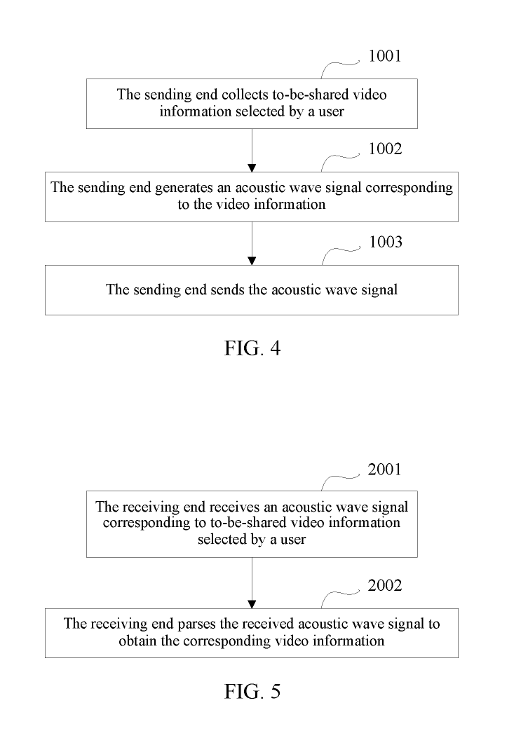

FIG. 4 is an exemplary flowchart illustrating a multimedia sharing method at a sending end according to an embodiment of the present disclosure. As illustrated in FIG. 4, the method may include the following steps:

In Step 1001, the sending end collects to-be-shared video information selected by a user.

In Step 1002, the sending end generates an acoustic wave signal corresponding to the video information.

In Step 1003, the sending end sends the acoustic wave signal.

For example, the video information includes a video address.

For example, a request for transmitting the acoustic wave signal is sent, and the acoustic wave signal is sent when a positive acknowledgement for the request is received.

FIG. 5 is an exemplary flowchart illustrating a multimedia sharing method at a receiving end according to an embodiment of the present disclosure. As illustrated in FIG. 5, the method may include the following steps:

In Step 2001, the receiving end receives an acoustic wave signal corresponding to the to-be-shared video information selected by a user; and

In Step 2002, the receiving end parses the received acoustic wave signal to obtain the corresponding video information.

It should be understood that, the embodiments of the multimedia sharing method are described in detail in the embodiments where the first user equipment and the second user equipment are in interaction with each other (as mentioned above), and details are not described herein again. In addition, a person skilled in the art may select, according to the present disclosure, any one of all the above embodiments, or a combination of two or more of all the above embodiments, to configure a user equipment, and other alternative embodiments also fall within the protection scope of the present disclosure.

With the multimedia sharing method and the user equipment provided by the embodiments of the present disclosure, rapid and convenient video sharing through acoustic waves may be achieved without the limitation of sharing through existing accounts of users, thereby improving user experience.

According to an embodiment of the present disclosure, there is provided with a non-transitory computer-readable storage medium storing executable instructions that, when executed by an electronic device, cause the electronic device to perform any one of above disclosed methods.

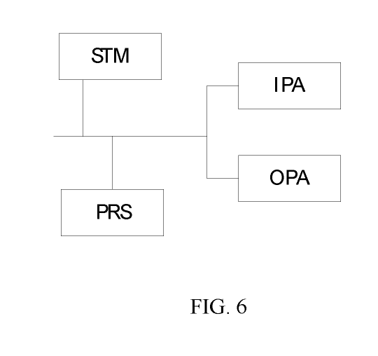

FIG. 6 illustrates a schematic hardware diagram of an electronic device for performing any one of above disclosed methods. According to FIG. 6, the electronic device includes one or more processors PRS and a storage medium STM. FIG. 6 shows one processor PRS as an example.

The electronic device can further include an input apparatus IPA and an output apparatus OPA.

The one or more processors PRS, storage medium STM and output apparatus OPA may be connected by a bus or other means. FIG. 6 shows a bus as an example for connection.

Storage medium STM is a non-transitory computer-readable medium for storing a non-transitory software program, a non-transitory computer-readable program and module, for example the program instructions/module for performing an above described method (e.g. collecting module 11 and acoustic wave signal generating module 12 shown in FIG. 2, and parsing module 22 shown in FIG. 3). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but are not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure can exist in various forms and includes but is not limited to:
(1) A mobile communication device which is capable of performing mobile communication function and is with a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can get access to a mobile network. Such a terminal device includes: a PDA, a MID and a UMPC etc., for example iPad.
(3) A portable entertainment device which is capable of displaying and playing multimedia content. Such a device includes: an audio player, a video player (e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Although some embodiments of the present disclosure have been described in detail above with reference to the accompanying drawings, the present disclosure is not limited to specific details in the above embodiments. Various simple variations can be made to the technical solutions of the present disclosure within the scope of the technical idea of the present disclosure, and such simple variations all fall within the protection scope of the present disclosure.

It should be further noted that the specific technical features described in the above specific embodiments can be combined in any appropriate manner as long as no conflict occurs. To avoid unnecessary repetition, various possible combination manners will not be described in the present disclosure.

In addition, various different embodiments of the present disclosure may also be combined arbitrarily. Such combinations shall also be considered as the content disclosed by the present disclosure as long as these combinations are not departed from the concept of the present disclosure.

What is claimed is:

1. A multimedia sharing method, comprising:
collecting to-be-shared video information selected by a user;
generating an acoustic wave signal corresponding to the video information; and
sending the acoustic wave signal.

2. The method according to claim 1, comprising:
sending a request for transmitting the acoustic wave signal, and sending the acoustic wave signal in response to a positive acknowledgement for the request is received.

3. An electronic device, comprising:
at least one processor and a memory communicably connected with the at least one processor for storing instructions executable by the at least one processor;
wherein execution of the instructions by the at least one processor causes the at least one processor to:
collect to-be-shared video information selected by a user;
generate an acoustic wave signal corresponding to the video information for the electronic apparatus to send the acoustic wave signal.

4. The electronic device according to claim 3, wherein the video information comprises a video address.

5. The electronic device according to claim 3, wherein the electronic apparatus is further configured to: send a request for transmitting the acoustic wave signal, and send the acoustic wave signal when a positive acknowledgement for the request is received.

6. The electronic device according to claim 4, wherein the electronic apparatus is further configured to: send a request for transmitting the acoustic wave signal, and send the acoustic wave signal when a positive acknowledgement for the request is received.

7. The electronic device according to claim 5, wherein the electronic apparatus includes a loudspeaker.

8. An electronic device, comprising:
at least one processor and a memory communicably connected with the at least one processor for storing instructions executable by the at least one processor;
wherein execution of the instructions by the at least one processor causes the at least one processor to:
parse a received acoustic wave signal to obtain the corresponding video information, wherein the received acoustic wave signal corresponds to to-be-shared video information selected by a user.

9. The electronic device according to claim 8, wherein the video information comprises a video address.

10. The electronic device according to claim 8, wherein the electronic device includes a microphone.
